(19) United States
(12) Patent Application Publication
(10) Pub. No.: US 2007/0013158 A1
(43) Pub. Date: Jan. 18, 2007

(54) ASSISTED WALKING DEVICE

(76) Inventor: E. MIKE LONIELLO, MADISON, WI (US)

Correspondence Address: PATENT-TRADEMARK-COPYRIGHT. US, 2200 S. FORT APACHE ROAD #1213, LAS VEGAS, NV, 89117, US

(21) Appl. No.: 11/164,129

(22) Filed: Nov. 10, 2005

Related U.S. Application Data
(60) Provisional application No. 60/699,226, filed on Jul. 14, 2005.

(51) Int. Cl. B62M 1/00

(52) U.S. Cl. 280/87.021

(57) ABSTRACT

A assisted walking device is disclosed that is usable by an elderly or mobility impaired person to assist them in walking over various surfaces including paved surfaces, grassy surfaces, unpaved paths or surfaces, and natural terrain. The disclosed assisted walking device includes a frame with a set of four all-terrain wheels, a pair of rearwardly disposed handles over the frame to permit a user to support his/her weight and permitting unimpeded leg motion while walking, a centrally disposed seat for resting, a basket for storing items, and a performance monitoring device. The handles include an actively set and a non-actively set brake, such that the non-actively set brake automatically engages when a user loses control or releases the handle and the actively set brake permits a user to engage the brake to stop or impede motion.

This application claims priority to U.S. Provisional Application No. 60/699,226, filed on Jul. 14, 2005, the entire contents of which are also incorporated herein by reference.

### FIELD OF THE INVENTION

The present invention relates generally to walking devices, and more particularly to a wheeled walking device for assisting elderly or mobility impaired persons to walk in mixed terrains.

### BACKGROUND OF THE INVENTION

Walking devices are used by elderly and mobility impaired persons each day to assist them in their regular walking activities and also for their conditioning or rehabilitation. Usually, the walking devices are most helpful in flat and solid surfaces, such as hallways or sidewalks. However there are many places that do not have smooth walkways such as a beach or park where people enjoy walking or may need to walk. The problem with conventional walking devices is that they cannot be used in such areas or cause a person using such a walking device a great deal of inconvenience or hardship.

One walking device of the prior art is a modified wheelchair with a bidirectional seat and handle bars. This device features the traditional large pair of wheels on the rear axle under the seat and small swiveled wheels at the front. While providing a resting place for a walker, this device fails to solve problems encountered by a person walking on a beach or over non-paved terrain such as may be found in a park.

Other wheeled walkers have four wheels and a handled frame that provide some measure of stability to mobility impaired or elderly persons needing assistance while walking. Some of the wheeled walkers have a basket for carrying items, others have a seat for resting, and some have a folding frame for storage.

In some walking devices, a frame is provided for support without wheels that make it easier to move over non-paved or uneven surfaces; however, a user must lift and carry these walking devices. While these devices provide greater mobility over mixed terrain surfaces, these devices do not normally have a seat for resting or a basket for carrying items, such as a pet or groceries, and hence limit the useful distance for walking by many mobility impaired or elderly persons.

There is therefore a need for a walking device for mobility impaired or elderly persons that may easily be utilized over uneven or mixed terrain surfaces, and offer greater distance mobility and utility by providing a seat for resting and basket for carrying items.

### SUMMARY OF THE INVENTION

The present invention provides a wheeled walking device for assisting mobility impaired or elderly persons in walking over multi-faceted surfaces or terrain. The assisted walking device comprises a frame with handles at a level near or about the waist and disposed over the frame to permit a user to support a portion of his/her weight, over-sized wheels of a type similar to conventional garden carts or all-terrain bicycles, and a resting seat.

### BRIEF DESCRIPTION OF THE DRAWINGS

The accompanying drawings incorporated in and forming a part of the specification, illustrates several aspects of the present invention, and together with the description serves to explain the principles of the invention. In the drawing:

FIG. 1 is a side-overhead view of an embodiment of the assisted walking device of the present invention.

FIG. 2 is a side view of a brake assembly of an embodiment of the assisted walking device of the present invention.

FIG. 3A is a side view of a speedometer assembly of an embodiment of the assisted walking device of the present invention.

FIG. 3B is a side view of the transponder assembly attached to the speedometer assembly of an embodiment of the assisted walking device of the present invention.

FIG. 4 is an alternative embodiment of the assisted walking device of the present invention that includes an umbrella and detachable umbrella mount.

FIG. 5 is a view of the alternative embodiment of the assisted walking device of the present invention with the umbrella shown open and mounted on the umbrella mount.

### DETAILED DESCRIPTION OF THE INVENTION

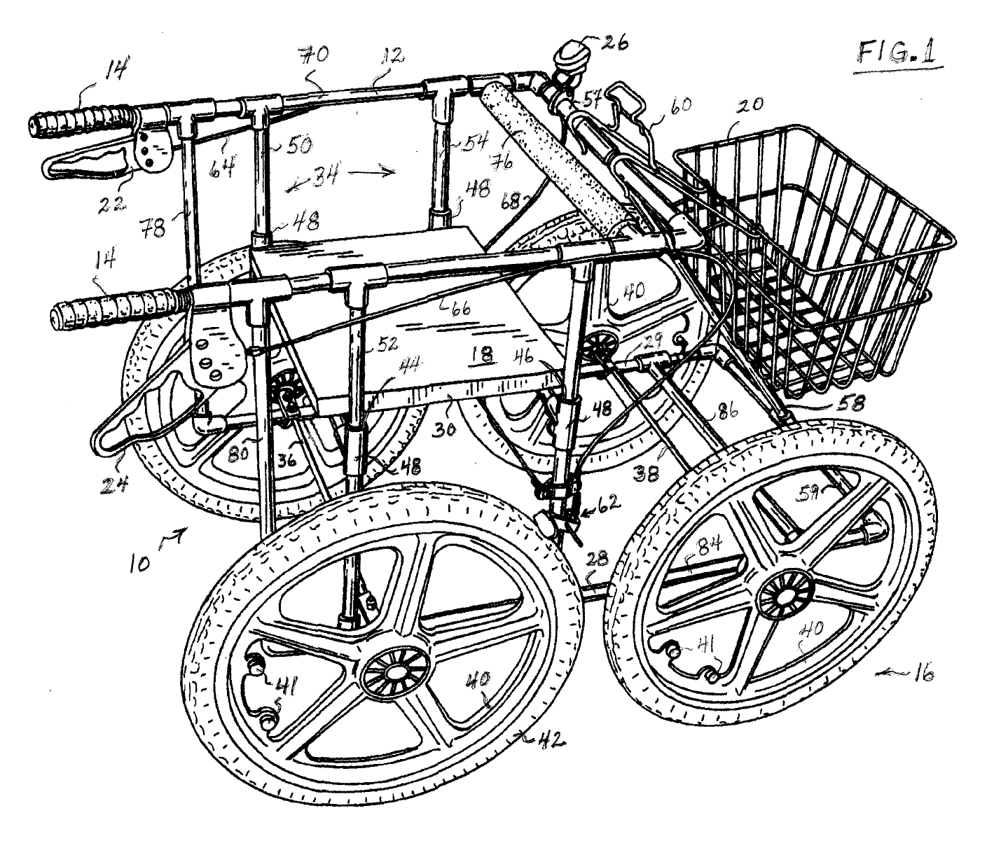

Referring to FIG. 1, an embodiment of the assisted walking device 10 of the present invention is shown that is usable by an elderly or mobility impaired person to assist them in walking over various surfaces including paved surfaces, grassy surfaces, unpaved paths or surfaces, and natural terrain. In the embodiment, assisted walking device 10 comprises a frame 12, handles 14, a set of four wheels 16 axially attached to frame 12, seat 18, basket 20, brake handles 22, 24, and speedometer 26. Frame 12 comprises a tubular assembly which may be comprised of a rigid plastic, aluminum, or steel material sufficient to support the weight of a user, a pet, and various items such as groceries or supplies. Frame 12 includes horizontal lower base portion 28, and intermediate level portion 30, and upper base portion 32 that are connected with a set of vertically oriented tubular support members 34. Handles 14 are comprised of a gripping material such as a ridged rubber or flexible plastic material that slips over an area of the upper base portion 32 that is disposed rearward and provides a gripping surface for a user. The set of four wheels 16 are mounted on the horizontal base portion 28 with axles 36, 38 and comprised of oversized rims 40 with reflectors 41 and oversized inflatable tires 42 as conventionally utilized with garden carts or all-terrain bicycles, such as rims 40 having a twenty inch diameter and tires 42 mountable on the rims and inflatable to approximately fifty pounds per square inch (psi). Reflectors 41 are conventionally available to reflect lights such as light beams of a car and to identify the location of assisted walking device 10, such as when a user is crossing a street. Additional reflectors may be connected such as on handles 14 and facing rearward or placed on basket 20 facing forward. Additionally a headlight (not shown, such as conventionally available and operated with batteries) may be placed on a forward location such as basket 20 or axial portion 57 or similar location to provide light for a user as the user navigates in areas of reduced lighting.

Intermediate level portion 30 is comprised of a pair of rigid axial members 44, 46 that are secured with T-joints 48 connected to tubular support members 50, 52, 54, 56 which are part of the set of vertically oriented tubular support members 34. Seat 18 is mounted on axial members 44, 46 and comprised of a rigid material capable of supporting the weight of a user, such as a block of one inch thick wood approximately twenty-four inches across and twelve inches deep. Basket 20 is comprised of a metal mesh framework and is supported by forward support member 58 which is part of the set of vertically oriented tubular support members 34 connecting forward axial portion 57 of upper base portion 32 to forward axial portion 59 of lower base portion 28. Basket 20 is removably attached to forward axial member 57 with clamp 60. Brake handles 22, 24 are connected to upper base portion 32 and disposed under respective of handles 14. Brake handle 24 is connected through cable 66 to brake apparatus 62 which is mounted on support member 56; similarly, brake handle 22 is connected through cable 64 to a brake apparatus (not shown) which is mounted on support member 54. Speedometer 26 is connected to forward axial portion 57 and connected to the axle of one of the wheels through cable 68. Speedometer 26 is comprised of a conventional speedometer such as is attached to conventional bicycles. Upper base portion 32 includes longitudinal portions 70, 72. Axial portions 57, 74 connect longitudinal portions 70, 72 and provide rigidity to maintain the parallel relationship of longitudinal portions 70, 72 together with the set of vertically oriented tubular support members 34 so that a user can support his/her weight without deforming the shape of assisted walking device 10. Axial portion 74 also provides support to the back of a user when seated on seat 18. Axial portion 74 includes a pad 76 to cushion the back of a user. Pad 76 surrounds axial portion 74 and is comprised of a rubber or Styrofoam material. Seat 18 is located sufficiently centrally over the lower base portion 28 to provide a stable platform when a user is seated facing rearward and leaning against pad 76. Upper base portion 32 is disposed rearward with respect to lower base portion 28 so that a user has sufficient space between longitudinal portions 70, 72 to move his/her feet and legs while walking and using handles 14 for support without striking seat 18 or axle 36. The disposition of upper base portion 32 with respect to lower base portion 28 also provides stability permitting all or a substantial portion of a user's weight to be supported by handles 14 and reduces the risk of tipping assisted walking device 10 when the user's weight is supported by handles 14. A user can additionally add counter weight in basket 20 or along the forward locations if necessary. Vertical portions 78, 80 are disposed rearward of axle 36 and provide additional support to longitudinal portions 70, 72. Longitudinal portions 82, 84 of lower base portion 28 are disposed forward of forward axle 38 and are connected and supported with axial portions 59, 86. The forward positioning of the lower base portion offers additional counter-balance to avoid tipping when a user supports his/her weight on handles 14.

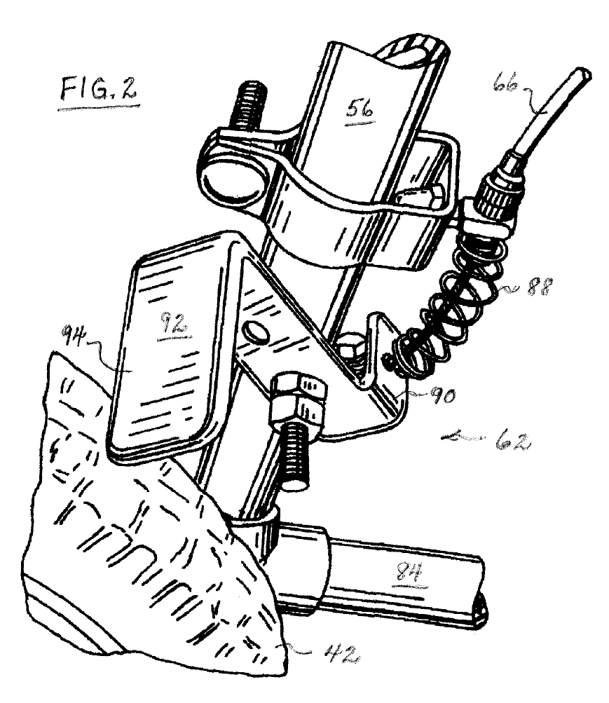

Referring to FIG. 2, an embodiment of brake assembly 62 is shown connected to vertical portion 56. Spring 88 maintains pressure on the rearward portion 90 of brake lever 92 when brake handle 24 is not compressed towards handle 14 by a user and forward portion 94 is not engaged with tire 42. A user stops assisted walking device 10 by compressing brake handle 24. The brake assembly (not shown) connected to brake handle 22 operates opposite to brake assembly 62; and as long as brake handle 22 is not compressed, the brake is engaged with tire 42. So that when a user loses control of assisted walking device 10 or stops to rest and sits on the seat, assisted walking device 10 becomes or remains stationary unless or until brake handle 22 is compressed towards handle 14.

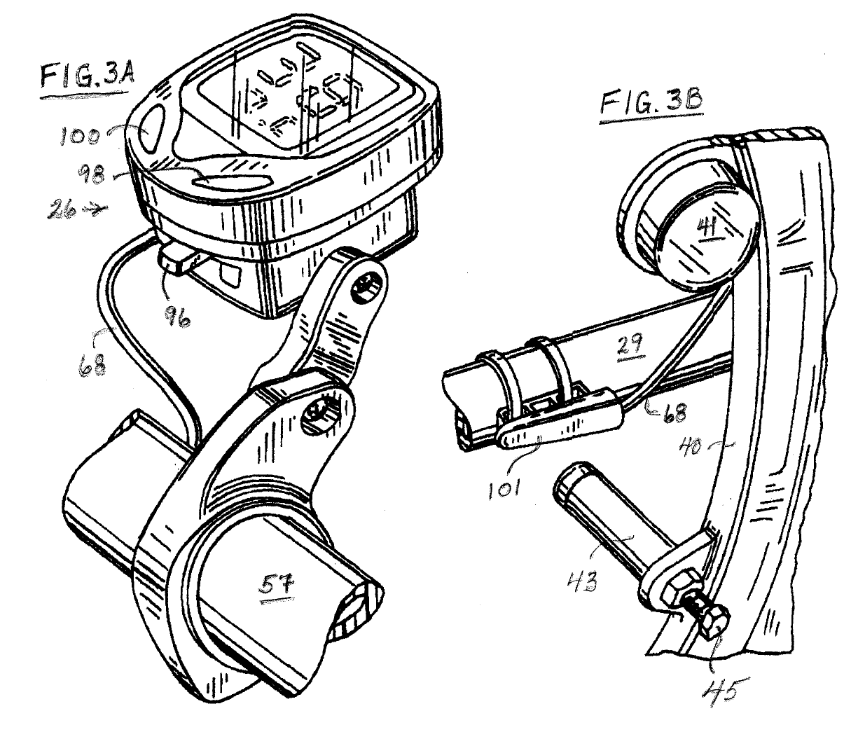

Referring to FIG. 3A, an embodiment of speedometer 26 is shown connected to forward axial portion 57. Speedometer 26 includes a digital display and may include an odometer for measuring the distance traveled by a user, a clock with or without a timer, and a reset such as with button 96. Additional buttons 98, 100 may provide for viewing calories burn rate or total calories or similar displays as provided by conventional displays on exercise equipment. Referring to FIG. 3B, speedometer 26 connects to transponder (and/or sensor) 101 through cable 68. Transponder 101 responds to magnet 43 which connects to rim 40. Magnet 43 rotates on rim 40 and produces a magnetic field sufficient to be sensed as the magnet comes into proximity with transponder 101 during each revolution of the wheel and causes an electrical impulse to be transmitted from transponder 101 to speedometer 26. Magnet 43 is adjustable with bolt 45 to reduce or increase the gap between magnet 43 and transponder 101 as needed to produce the desired interaction between the two components and display on speedometer 26. Speedometer 26 and transponder 101 are conventionally available. Speedometer 26 includes conventional circuitry, such as a digital signal processor or application specific processor, for translating the impulses from the transponder into the user-related display information. As with conventional display packages, individual user data may be input to be used with the algorithms generating the user-related display information, such as calories burned. In the preferred embodiment, magnet 43 is attached to the forward left wheel. It may be appreciated that magnet 43 and transponder 101 may alternatively be connected to operate in conjunction with any of the other rims 40.

In the preferred embodiment, bolt 45 inserts through a PVC tube which is cut to a length to hold magnet 43 within about ⅛ inch of transponder 101. Magnet 43 has a threaded hub which accepts bolt 45. Bolt 45 has been sized and selected as a 6 mm bolt; however, the particular sizing is only one example as are any of the dimensions and sizes referred to within the description. Magnet 43 also has a collar which rests neatly against the PVC spacer where it is held in place by the bolt.

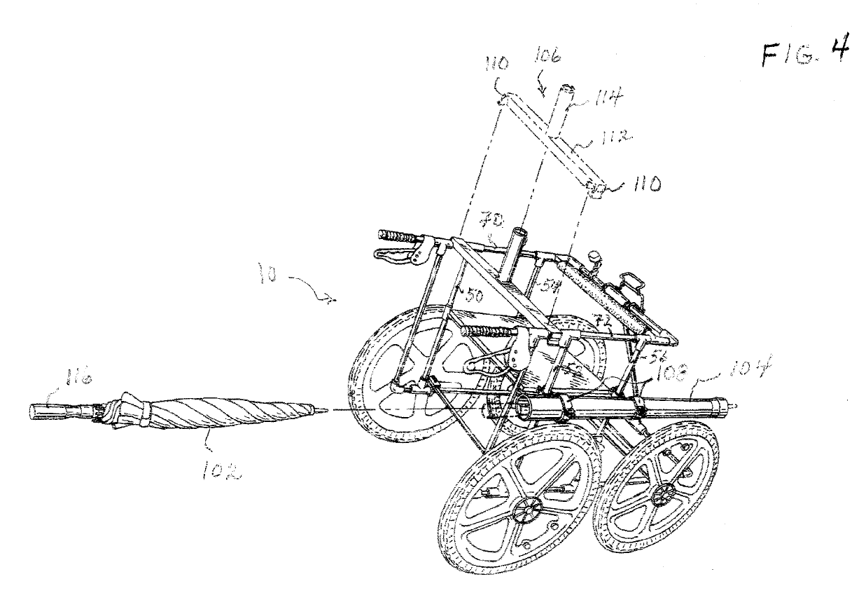

Referring to FIG. 4, an alternate embodiment of assisted walking device 10 is shown that includes storable umbrella 102, umbrella bin 104, and detachable umbrella mount 106. Umbrella 102 may be of a conventional design that may be stored within umbrella bin 104 during non-use. Umbrella bin 104 may be of a conventional design or may be produced from plastic or metal or similar substance that may be formed into a tube with sufficient inner diameter for easy insertion and removal of umbrella 102 by a user. Umbrella bin 104 is attached to assisted walking device 10 with clamps 108 that are connected to support members 52 and 56 or 50 and 54 so that both umbrella bin 104 and umbrella 102 are secure and non-obstructive during operation of assisted walking device 10. Clamps 108 may be formed with a rigid metal or plastic and may be adjustable to accommodate various width umbrella bins 104. The portion of clamps 108 that attach to the support members may also be adjustable as with a screw to permit umbrella bin 104 to be raised or lowered according to the preferences of a user.

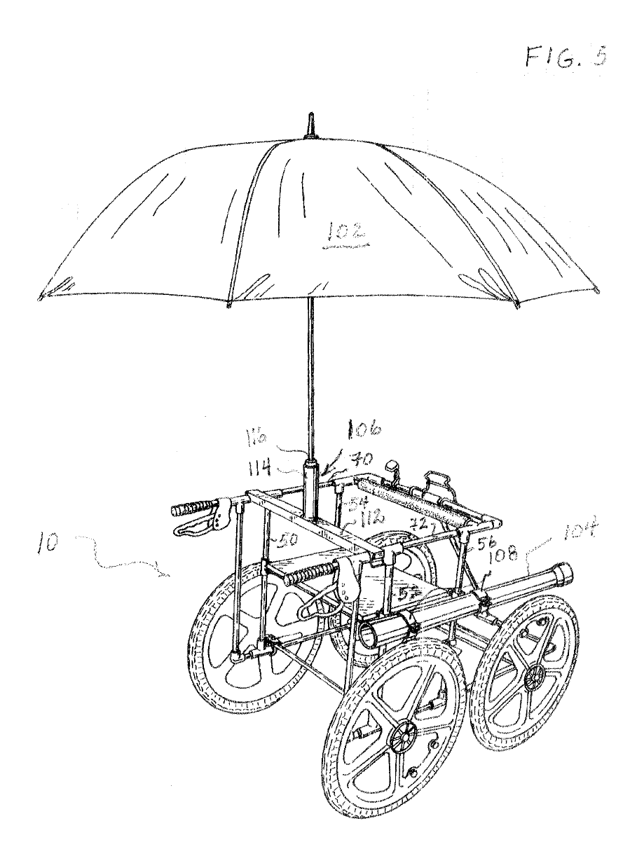

Umbrella mount 106 may be formed of a rigid metal or plastic that includes clips 110 at the ends of bar 112. Bar 112 fits between longitudinal portion 70, 72 and removably attaches to them with clips 110. Umbrella mount 106 also includes mounting rod 114. Mounting rod 114 includes a hollow portion for receiving and securing umbrella handle 116 such that umbrella 102 (as shown in FIG. 5) is maintained upright and supported by umbrella mount 106.

The foregoing description includes the preferred embodiment of the present invention. The embodiments described are presented for purposes of illustration and description. It is not intended to be exhaustive or to limit the invention to the precise form disclosed. Obvious modifications or variations are possible in light of the above teachings. For instance in one embodiment, additional forward weighting to shift the center of balance can be provided either by choice of materials or by additional weighting of the forward portion of the lower base portion in order to reduce the possibility of tipping assisted walking device 10 backward while being used. Additionally, in another embodiment, the height of upper base portion 32 can be modifiable as by adding finger or wrench adjustable screws or bolts to T-joints 38 and having upper portions of each of the set of vertical members being slidable into the lower portions of those members as with conventional bicycle seats. The embodiments described are chosen to provide the best illustration of the principles of the present invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably titled.

What is claimed is:

1. An assisted walking device for assisting elderly or mobility impaired persons in walking over various surfaces, the assisted walking device including a lower base portion, an upper base portion, a vertical portion, and a set of all-terrain wheels;
the lower base portion including two axles set a pre-determined distance apart, the set of all-terrain wheels being attached to said axles;
the upper base portion including a forward and rearward area, the forward area being disposed over the axles, and the rearward area being disposed behind the axles;
the vertical portion connecting the upper base portion and the lower base portion a predetermined distance apart;
the lower base portion including a forward area being disposed forward of the axles and shifting the center of gravity forward over the axles; and
the rearward area of the upper base portion including a handle portion for supporting all or a portion of the weight of a user.

2. The assisted walking device as in claim 1, the assisted walking device including an intermediate base portion fixed a predetermined between the lower base portion and upper base portion; the intermediate base portion including a seat disposed above at least one of the axles; the forward area of the upper base portion including a back rest for supporting the back of a user while seated.

3. The assisted walking device as in claim 2, the assisted walking device including a basket for carrying items; the basket connecting to the forward area of the upper base portion.

4. The assisted walking device as in claim 1, the all-terrain wheels being of sufficient size and strength to roll over non-paved terrain.

5. The assisted walking device as in claim 1, the assisted walking device including a first brake and a first brake handle for controlling the first brake, the first brake connecting to at least one wheel and being in locked position when the first brake handle is not controlled by the user.

6. The assisted walking device as in claim 5, the assisted walking device including a second brake and a second brake handle for controlling the second brake, the second brake connecting to at least one wheel and being in an unlocked position unless controlled by the user.

7. The assisted walking device as in claim 1, the assisted walking device including a monitoring device connected to the upper base portion for monitoring the performance or progress of a user.

8. An assisted walking device for assisting elderly or mobility impaired persons in walking over various surfaces, the assisted walking device including a lower base portion, an upper base portion, a vertical portion, a walker cover and a set of all-terrain wheels;
the lower base portion attaching to the set of all-terrain wheels;
the upper base portion including a forward and rearward area;
the vertical portion connecting the upper base portion and the lower base portion a predetermined distance apart;
the rearward area of the upper base portion including a handle portion for supporting all or a portion of the weight of a user; and
the walker cover being attachable to the upper base portion to protect a user from the elements.

9. The assisted walking device as in claim 8, the assisted walking device including an intermediate base portion fixed a predetermined between the lower base portion and upper base portion; the forward area of the upper base portion including a back rest for supporting the back of a user while seated.

10. The assisted walking device as in claim 9, the assisted walking device including a basket for carrying items; the basket connecting to the forward area of the upper base portion.

11. The assisted walking device as in claim 8, the all-terrain wheels being of sufficient size and strength to roll over non-paved terrain.

12. The assisted walking device as in claim 8, the assisted walking device including a first brake and a first brake handle for controlling the first brake, the first brake connecting to at least one wheel and being in locked position when the first brake handle is not controlled by the user.

13. The assisted walking device as in claim 12, the assisted walking device including a second brake and a second brake handle for controlling the second brake, the second brake connecting to at least one wheel and being in an unlocked position unless controlled by the user.

14. The assisted walking device as in claim 8, the assisted walking device including a monitoring device connected to the upper base portion for monitoring the performance or progress of a user.

15. The assisted walking device as in claim 8, the walker cover comprising an umbrella.

16. The assisted walking device as in claim 8, the assisted walking device including a cover storage receptacle; the walker cover being collapsible and storable substantially within the storage receptacle.

17. The assisted walking device as in claim 8, the set of all-terrain wheels including at least one light reflector on each wheel.
